(19) United States
(12) Patent Application Publication
(10) Pub. No.: US 2012/0136565 A1
(43) Pub. Date: May 31, 2012

(54) Filtering social networking information to provide customized mapping

(75) Inventors: Sean P. Kennedy, San Diego, CA (US); Fredrik Carpio, San Diego, CA (US); Adrian Crisan, San Diego, CA (US); Rommel M. Garay, San Marcos, CA (US); Gary R. Lyons, San Diego, CA (US); Edward T. Winter, San Diego, CA (US); Michael Chang, San Diego, CA (US); Toyoaki Kishimoto, San Diego, CA (US); Andrew L. Lawton, San Marcos, CA (US)

(73) Assignee: Sony Corporation, Tokyo (JP)

(21) Appl. No.: 12/926,620

(22) Filed: Nov. 30, 2010

(51) Int. Cl. G01C 21/32

(52) U.S. Cl. 701/409; 701/436

(57) ABSTRACT

User-specific information such as the social networking cloud of relevant metadata is used to find real-time information and provide visual feedback to users regarding the presence of other users at particular locations. In one example, the information is displayed on localized map images, with visual indicators such as dots indicating the presence of other users having desired characteristics.

### BACKGROUND OF THE INVENTION

1. Field of the Invention

This application relates generally to methods and apparatuses for filtering social networking information to provide customized mapping of the location of other device users.

2. Description of the Related Art

As social networking becomes more prevalent there will be an increasing desire to search the social networking universe for information on locations and events that users are interested in.

At present web searches implement a search engine that maintains a history, which is insufficient, given the amount of user-specific information available through social networking and otherwise.

What is needed is improved usage of user-specific information, in connection with conveying information about events to users.

### SUMMARY OF THE INVENTION

User-specific information such as the social networking cloud of relevant metadata is used to find real-time information and provide visual feedback to users regarding the presence of other users at particular locations. In one example, the information is displayed on localized map images, with visual indicators such as dots indicating the presence of other users having desired characteristics.

The present invention can be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the present invention are more fully disclosed in the following specification, reference being had to the accompanying drawings, in which:

FIGS. 1 A-B are schematic diagrams illustrating examples of computer networks 100a-b in which social networking customized mapping is provided;

FIG. 2 is a flow diagram illustrating an example of gathering and filtering social networking information in support of customized mapping;

FIG. 3 is a flow diagram illustrating an example of filtering social networking information in conjunction with location and event determination and parameter filtering;

FIG. 4 is a flow diagram illustrating an example of filtering social networking information with filtering based upon social networking connection parameters;

FIG. 5 is a block diagram illustrating an example of a module for filtering social networking information to provide customized mapping; and

FIG. 6 is a display diagram illustrating an example of a map image.

### DETAILED DESCRIPTION OF THE INVENTION

In the following description, for purposes of explanation, numerous details are set forth, such as flowcharts and system configurations, in order to provide an understanding of one or more embodiments of the present invention. However, it is and will be apparent to one skilled in the art that these specific details are not required in order to practice the present invention.

User-specific information such as the social networking cloud of relevant metadata is used to find real-time information and provide visual feedback to users regarding the presence of other users at particular locations. In one example, the information is displayed on localized map images, with visual indicators such as dots indicating the presence of other users having desired characteristics.

Displaying a map image with indicators corresponding to user devices may comprise identifying a geographical area of interest, and then accessing location information corresponding to other users (as determined from the location of user devices). Social networking information (metadata) corresponding to the users is also accessed and filtered to distinguish among subsets of the other users. The filtering of this information supports display of a map image corresponding to the geographical area of interest, along with location indicators, such as dots or other graphical images. The location indicators show the locations of the user devices (and thus the users). Furthermore, the location indicators can be displayed with differing visual characteristics depending upon the characteristics of the users, based upon the filtering of the metadata.

In this fashion, a subset of users with specific parameters may be highlighted in the display of the map image, and more particularly in connection with an event or location that is also shown on the map image.

Additionally, the user can actively search for other users with particular parameters. For example, a user device is configured to receive a specified set of user parameters. The filtering of the metadata is then performed according to the specified set of user parameters to result in a targeted subset of the plurality of users. Depicting the location indicators for the targeted subset of users is then performed with particular visual characteristics to visually distinguish the targeted subset of users from other users.

Still further, the map image may be managed to show only particular events or locations, along with users having specified parameters. Here, the user device is configured to receive a specified set of location parameters, and identify location(s) on the map image that satisfy the specified set of location parameters (e.g., dance club, restaurant, etc.). In connection with displaying these event locations, there is filtering of the metadata such that the targeted subset of the plurality of users includes only those that are located within a range of the location(s) on the map image.

Finally, the social networking information may be used to further tailor the filtering and depiction of other users on the map image. This, for example, may be provided in the context of social networks that allow users to indicate distinguishable levels of connection with other users. This may be as simple as those other users that are “friends” on a particular social networking site, or more specific gradations of connection may be provided. According to this aspect, the metadata includes information indicative of distinguishable levels of connection available for specification in the social networking information, and receiving the set of user parameters includes a specification of a given level of connection, such that the targeted subset of the plurality of users includes only those users satisfying the given level of connection. In this fashion, the user may receive feedback concerning a smaller, more closely connected subset of other users on the map image.

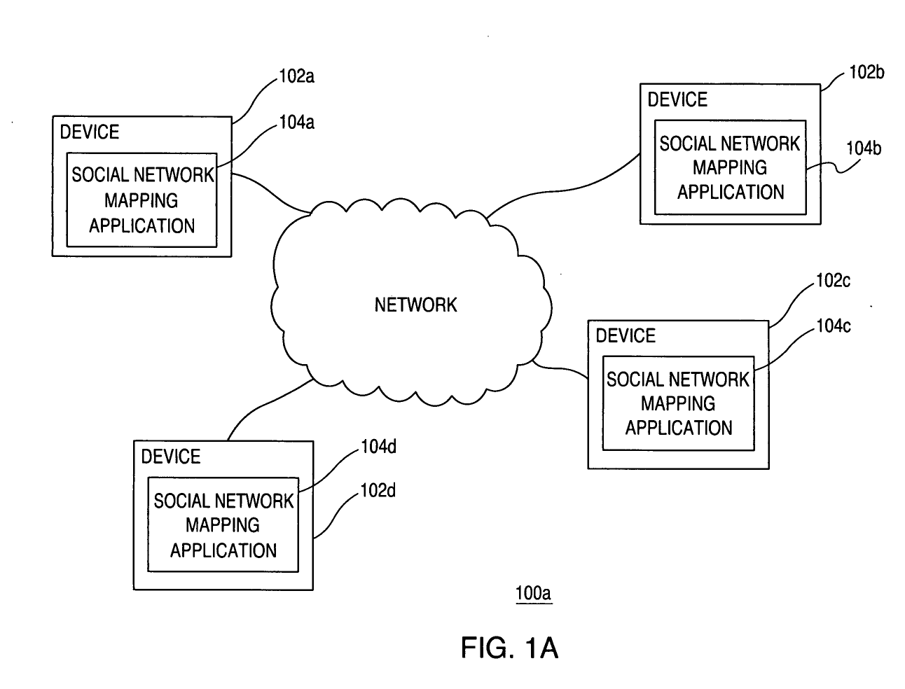

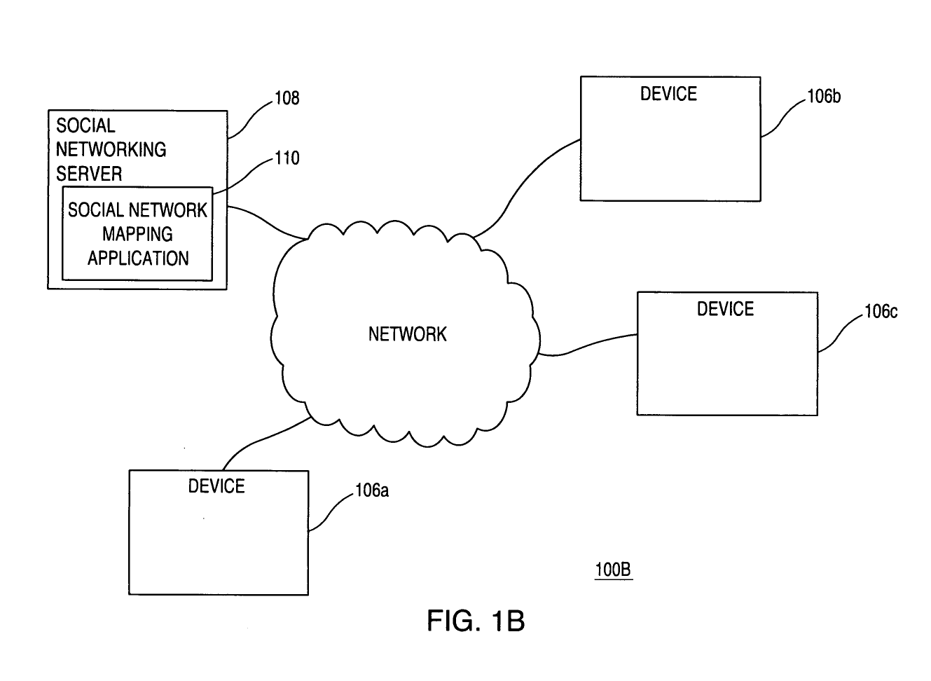

FIGS. 1A-B are schematic diagrams illustrating examples of computer networks 100a-b in which social networking customized mapping is provided. FIG. 1A illustrates several user devices 102a-d each having a social network mapping application 104a-d.

The user devices 102a-d are preferably handheld devices, such as a smart phone, although they may be any conventional computing device. They also preferably include a form of location determining technology. An example is GPS functionality found within the computing device itself. There are various alternatives. One example is detecting location in a cellular based system. Another example is determining location based upon the location of an access point through which a device engages a network. These and various other examples of location determining technology may be readily implemented.

Additionally, there are examples wherein a user may use a conventional computing device such as a workstation or laptop to implement the social network mapping application 104a-d functionality, wherein the conventional computing device itself does not include location determining technology. There, the user may input location information to retrieve map information with pertinent depictions of other users currently using devices with location determining technology.

The network over which the devices 102a-d may communicate may also implement any conventional technology, including but not limited to cellular, WiFi, WLAN, LAN, or combinations thereof.

In one embodiment, the social network mapping application 104a-d is an application that is installed on the user device 102a-d. For example, the user device 102a-d may be configured with a web browser application, with the application configured to run in the context of the functionality of the browser application. This configuration may implement a peer-to-peer architecture wherein the social network mapping applications 104a-d respectively collect and distribute social networking metadata as well as location information in support of the functionality described further below.

As an alternative, as illustrated in FIG. 1B, the computing devices 106a-c may respectively access a social networking server 108, such as through conventional web browsing, with the social networking server 108 collecting and distributing the social networking metadata and location information in a more centralized fashion. As still another alternative, the functionality may be divided between the computing devices and a social networking server.

Still further, the computing devices and/or social networking server may implement other services that support the described functionality. For example, they may port or embed mapping functionality from a map service provider.

The social network mapping application uses social networking, statistical analysis, and location based distribution to manage groups, friends, locations, and events.

The application gathers metadata about different locations and users and provides a corresponding map that depicts the users accordingly. For example, a map of a given location can be rendered to further include “blue” and “pink” dots that respectively represent users with either common on non-common parameters. Some examples of segregating other users may be based upon the following parameters:

By frequency the person visits a given location;

By type of phone or handheld device they are using;

By online service provider (e.g., AT&T vs. Verizon);

By gender;

By computing preference (PC vs. Mac);

By zodiac sign;

By number of Sony products owned;

By movie preference;

By music preference;

Etc.

The data presented on the “dots” map allows for location determination, contact and avoidance; all based on the user defined parameters. For example, suppose that a user wants to find a dance club with techno music in the downtown area, with lots of single women. The user specifies that the positive data should be shown with pink dots. The application gathers data from the social networking “cloud” on device location via GPS tags or other location determining technology. The application also gathers metadata based on the parameters of all the users in the given area. The application then generates and displays a map of the downtown area specified and highlights each person in the area with pink or blue dots. The map image readily illustrates locations with the higher concentrations of pink dots, and may further recommend a given location with the highest concentration.

For example, the application would use the following equations in order to carry out this functionality.

Cl=(D/Mt within R of L); (1)

P=(U/W within R of Cl) filter by G; and (2)

Show C1 & P, (3)

where:

Cl=Club locations with Techno in downtown,

D=Dance Club locations in the specified area,

Mt=“Techno Music” tagged Clubs,

R=Range of Location area (e.g., 2 mile or other specified radius),

L=Location (e.g., downtown location input by user, or current user location),

P=Pink dots,

U=Users in Location,

W=Female Users in Location, and

G=Current Geo-tag of User.

Further functionality may be provided in connection with the social networking application to refine or use the search results. For example, upon completion of the search, the user making the search can then invite friends in the downtown area to join him.

Various techniques can be used to identify the universe of users and the corresponding parameters. For example, the user log-ins from everyone using the application can be used to determine common visitors by location. Additionally, parameters may be actively or passively collected for the users and maintained in association with the social network mapping application, the social network itself, or combinations thereof.

The “gather” parameters can be managed at the search stage or the at the invite stage. That is, a list of parameters can be input by the user with an initial query, and then the list may be refined in connection with a particular invite.

The user may control further usage of the invite information. For example, the user may specify that the other users receiving the invites can't forward the invites without a permission setting by the user making the search/invite.

According to another aspect, the social network mapping application supports the finding of particular friends based upon a specified level of connection between the user and the other users. With this aspect, there is similar rendering of search results to distinguish desired target users from other users. However, there is the additional functionality of specifying or determining how strongly connected the user is with any other users in the specified area. For example, within a specified area, the application may be queried to identify all “friends” currently available within the specified area. Alternatively, all friends of a configurable level within the specified area may be identified and displayed.

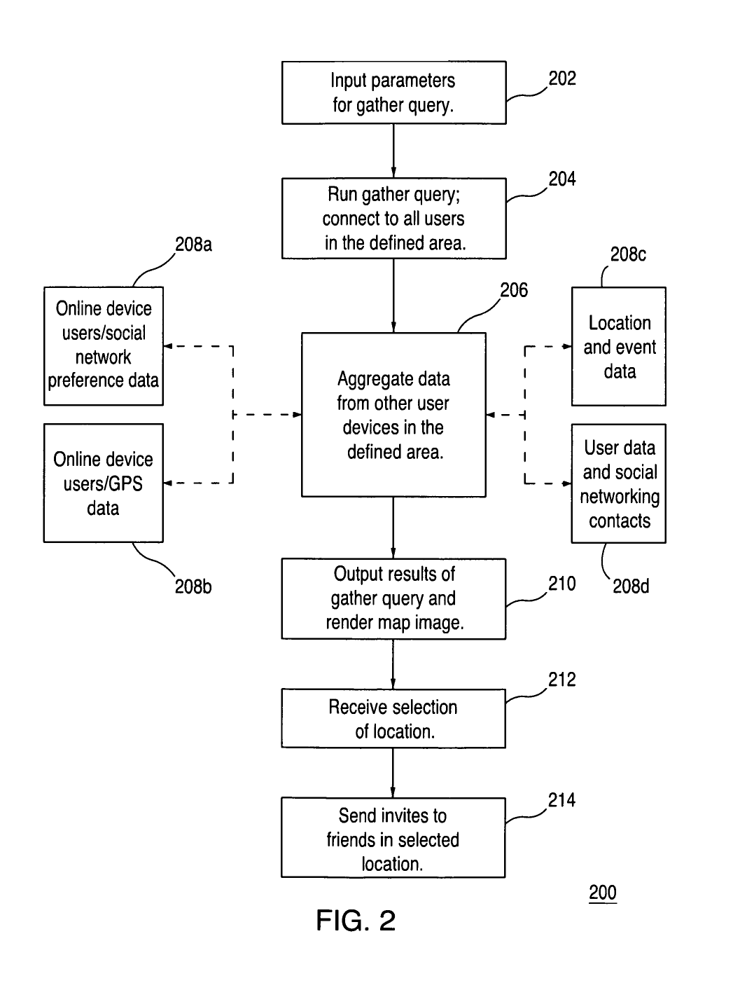

FIG. 2 is a flow diagram illustrating an example of gathering and filtering social networking information 200 in support of customized mapping. Initially, the user inputs 202 parameters to generate a “gather” query. These may be referred to as the gather parameters. The input may be based upon parameters such as user parameters specifiable in connection with the social network metadata as described above. A conventional display with a menu of potential selections among the various parameters may be used to receive the input. A defined area may be specified, which may be based upon the current location of the user device or another specified location, and may be further defined based upon a radius from the current location.

The application then runs 204 the gather query. Initially, this entails identifying the users within the currently defined area. In embodiments involving a peer-to-peer approach, this may entail queries to identify other users within the defined area (i.e., other users who also have the social network mapping application installed). In embodiments wherein the functionality is more centralized, the query may be a server query, which prompts the server to access the current location information of users to identify those in the currently defined area.

The application then aggregates 206 data corresponding to users (devices) within the defined area, in order to determine those users meeting the specified criteria. A variety of information is accessed in order to determine both the location information and the user parameters. This includes the preference data of the online device users 208a; location information such as GPS data for the device users 208b; location and event data for the defined location 208c; and the user data and social networking contacts of the requesting user 208d.

The “Online Device Users/Social network preference data” (208a) preferably refers to data gathered from social networking sites. For example, the application searches for users in the defined area, aggregates their social networking IDs, searches the social networking sites for the owners page, and then aggregates data on the users' interests (likes and dislikes).

“Online Device Users/GPS data” (208b) refers to data gathered from the various devices in the defined area which are enabled with GPS location devices. The Geo-tag can be queried since the device is typically in contact with a satellite whenever it is turned on and active. The Geo-tag can be used to pinpoint the device owner's location in relationship to the area of the search parameter.

Online “Location and Event data” (208c) refers to data gathered from search engines about specific locations and events that meet the search parameters for the data to be aggregated. This data includes metadata tags which include the geographic location, search keywords, user reviews, rating, contact information, etc.

Online “User data and Social Networking contacts” (208d) refers to data gathered from Social Networking sites about the User. It checks their contact data, likes and dislikes, etc. This data can then be used to confirm where the contacts are and if the are in the area of the search parameter.

It should be noted that in a preferred example the aggregated data is not presented to the user of the application. Only after the algorithm and filter run does the user get to see the map with the positive parameter data. This prevents the user from unwarranted intrusion into the personal data of the people subject to the search query. The user is only exposed to the resulting events/locations and the locations of persons close to the area meeting the search parameters. Designs may vary depending upon how much information distribution and privacy protection is preferred.

The data is then filtered according to the input parameters in the gather query. The results of the gather query are then output 210. The output may be reflected in the depiction of a map image for the defined area, with depictions according to those connected users that satisfy the input parameters, such as via dots of a specified color as described previously.

The application is further configured to receive 212 a selection of an event or location within the defined area. For example, the results may indicate a reasonable concentration of targeted users at multiple different locations. Selection of one of the locations further refines the subset of user devices according to the selection. It should be noted that the “location” may correspond to an event or establishment that is depicted on a map image, such as a retail location, entertainment venue, or the like. It may alternatively be a public location that may be specified by simply indicating the location on the map with conventional mouse and click commands.

Once the map image has been rendered and any (optional) additional selections of particular locations have been made, the user may send 214 invites to the targeted users. The invites may be sent using an instant message, or other message that is sent to the targeted users such as one sent through the social networking application.

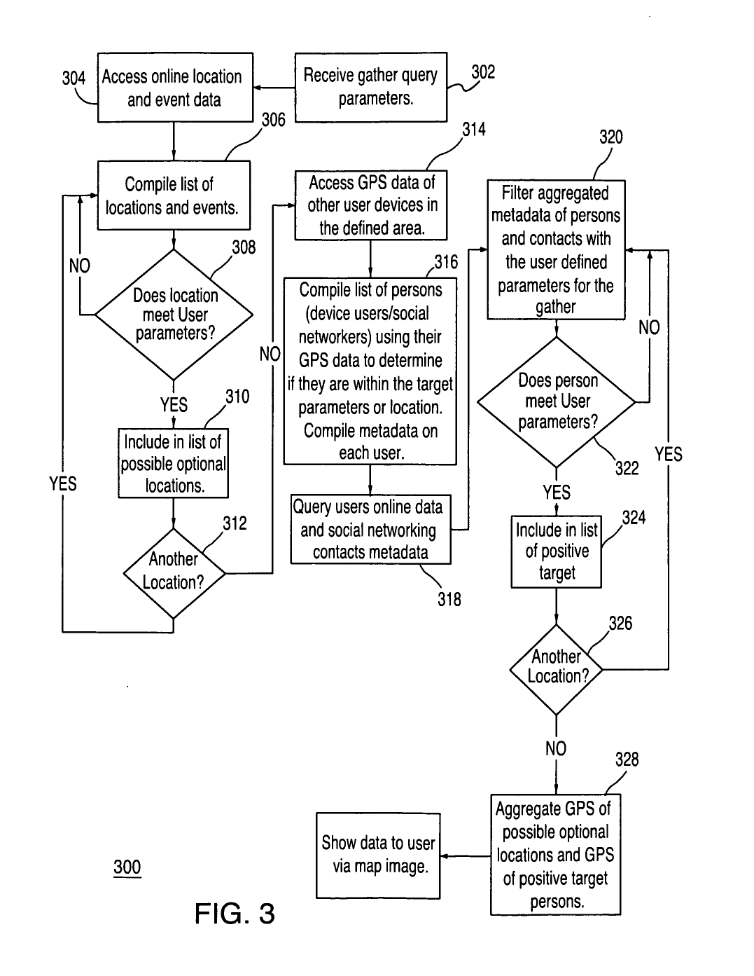

FIG. 3 is a flow diagram illustrating an example of a process 300 for filtering social networking information in conjunction with location and event determination and parameter filtering.

The process 300 similarly commences with a gather query 302 wherein the application receives input of gather parameters specifying parameters of targeted users, as well as desirable characteristics of locations. The currently defined area may also be input or updated in conjunction with the mapping facility of the device.

The application may also retrieve and convey a list of events and locations of interest, by accessing 304 online location and event data, and then compiling 306 a list of locations and events for the defined area. This may be performed by a query to the mapping service using the criteria specified in the user input, or a query to a locally maintained database of locations and events.

The application examines candidate locations within the defined area to determine 308 whether they meet the user parameters, adding 310 to them to the list of possible optional locations and progressing through the list until it is determined 312 that there are no further locations to review.

The application also accesses 314 the location information (e.g., GPS data) for the other user devices within the defined area. The application uses this information and compares it to the list of possible optional locations to compile 316 the list of users within the possible optional locations.

Next, the social networking information (metadata) for the other users is accessed 318 and then filtered 320 according to the gather parameters in order to identify those users that are both within range of the optional locations and satisfy the user parameters specified in the query. This is performed by progressing through the list of possible matches. When it is determined 322 that the user matches the specified parameters, they are included 324 in the list, with determinations 322 made until it is determined 326 that there are no other users to review.

Once all of the information about possible optional locations and positive target users is aggregated 328, the map image is generated to depict both the matching locations and the corresponding indicators for the other users. As with the previous example, a selection among these locations may be made, and a message may be sent to the subset of users that are selected.

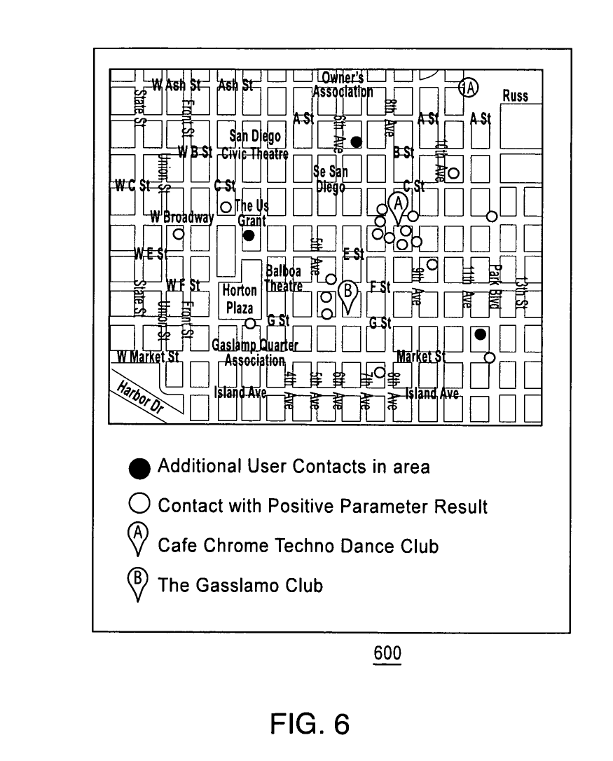

FIG. 6 is a display diagram illustrating an example of a generated and rendered map image 600. As evident from the figure there are two locations “A” and “B” that were determined to have met the parameters, as well as corresponding indicators corresponding to the other users in the area. As indicated, a first set of users are indicated as having a positive parameter result (they satisfy the user parameters specified in the query), and a second set of users are indicated within the area, but not in a visual depiction that indicates a positive parameter result. Additionally, the locations of the users in relation to the two locations “A” and “B” are depicted. Here, the concentration of users matching the query parameters is clearly higher at location “A”, so presumably the user will wish to select that location (although this would of course be optional).

Following such a selection, an invite can be sent to all of the users matching the query parameters as described. This, for example, may be a message stating “I see that you're not far from the Café Chrome, I'm going to head over—you should meet me there”. The message may be sent to all of the users with the positive parameter result, or may be limited to those within a predetermined or configurable radius of the selection location, as desired.

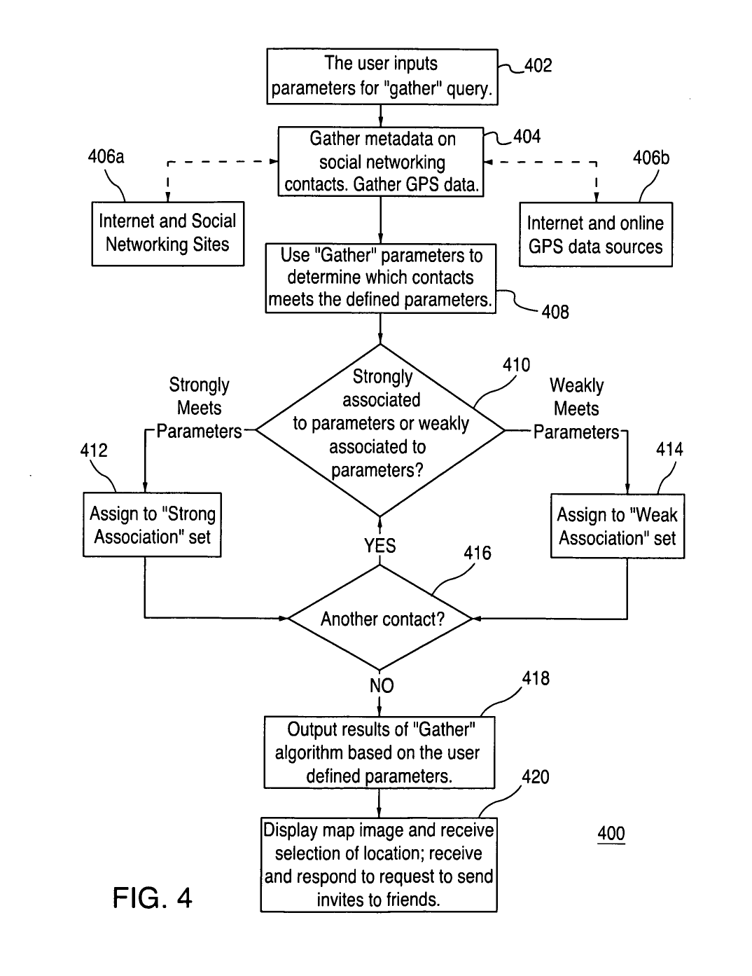

FIG. 4 is a flow diagram illustrating an example of a process 400 for filtering social networking information with filtering based upon the strength of a social network connection.

The process 400 similarly initiates with the user inputting 402 parameters for the gather query. The application then gathers 404 metadata corresponding to the user's social networking contacts, as well as location information such as GPS data. The metadata and location information are respectively accessed from internet and social networking sites (406a) and internet and online GPS data sources (406b).

The gather parameters are used 408 to determine which contacts meet the defined parameters. This is similar to the filtering described above. A variety of categorical parameters (gender, age, preferences, etc.) are used to identify an initial group of results. This may be done by a determination that the initial results match a majority or some predetermined percentage of the parameters in the gather query.

Following this a determination 410 is made as to whether each contact is strongly or weakly associated to the gather parameters. From the pool of initial results, this may be a determination that the match exceeds a given confidence level in terms of a match. A variety of techniques may be used to make this determination. For example, when the gather parameters are collected, the user may also be prompted to rank the importance of some or all of the parameters, such as the parameters of the potential contacts. A determination of matching is determined based upon a weighted determination as to which parameters match the input preferences. Thus, for example if gender is ranked as the most important parameter, the weighting scheme dictates that a matching contact having the incorrect gender automatically assigns 414 the contact into the weakly associated set of contacts, notwithstanding the possibility of a match on every other parameter. Similarly, a contact that matches the more important gather parameters is assigned 412 to the strong association set of results. The determination 410 of strong or weak association to the gather parameters continues until it is determined 416 that there are no further contacts in the initial results.

Strength or weakness can be defined according to “strength of connectivity”. A variety of techniques can be used to assess the strength of a connection between two users in a social network. In one example, a contact that the user interacts with multiple times a day, or beyond a given threshold (e.g., 5) is determined to have a strong connection to the other user/contact. This can be determined by the number of posts, IMs, etc. between the user and the contact as compared with other contacts. By contrast, a contact the user interacts with monthly will have a “weak” connection to the user.

Strength or weakness can also be defined according to “strength of parameter”. A contact the user shares parameter specific affinity with will have a “strong” connection to the user. For example, if one of the search parameters involves techno music, users that are determined to share techno music streams daily will have a strong association to each other in connection with the current query.

Still further, strength or weakness can be defined according to “strength of location”. This would be a measure of the distance the contact is from the parameter location. The farther away, the weaker the value.

Finally, strength or weakness of association can be defined according to a “strength of history”. This would be the number of events shared between the user and the contact which meets the parameters of the search. A contact with whom the user has been similarly located (e.g., they both attended the same techno music concert together) would have a “Strong” Connection.

A variety of processing techniques can also be used to enhance the level of sophistication with which the strength of association is determined, including but not limited to expert systems that learn what parameters are more important in the context of determining the strength of association, or regression based systems that determine the relative importance of parameters in connection with a search query parameter.

Additionally, a feedback mechanism may be provided to allow the user to provide input as to which of a set of contacts results in connection with a query were good suggestions. This allows the system to determine whether some parameters were more important than others in making the association between the user and the suggested set of other users.

At this point, the application outputs 418 the results of the gather algorithm based upon the user-defined parameters. The resultant listing may be displayed in list form and/or may be used in support of displaying 420 the map image wherein the strongly associated contacts are prominently displayed, either exclusively or in a color or some other visual depiction that renders them distinguishable from the weakly associated contacts. Again, the application supports receipt of a request to send invites to the subset of contacts that are strongly associated with the gather parameters.

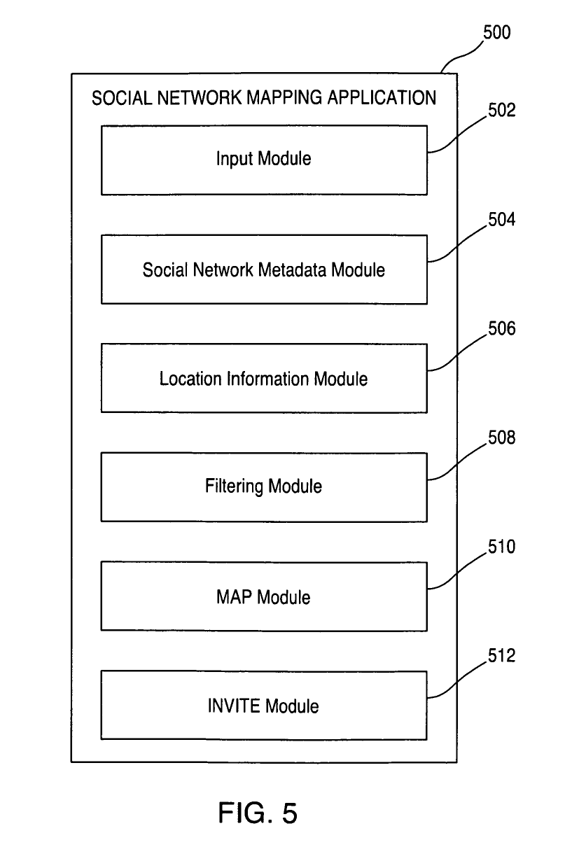

FIG. 5 is a block diagram illustrating an example of a social network mapping application 500 for filtering social networking information to provide customized mapping. The application 500 preferably comprises program code that is stored in a computer readable medium (e.g., compact disk, hard disk, etc.) and that is executable by a processor to perform operations in support of identifying a geographical area of interest, accessing location information corresponding to a plurality of users as determined from the location of a plurality of user devices respectively associated with the plurality of users, accessing social networking information comprising metadata respectively corresponding to individual ones of the plurality of users, filtering the metadata to distinguish among subsets of the plurality of users, displaying a map image corresponding to the geographical area of interest, and depicting location indicators on the map image, the location indicators showing the locations of the plurality of user devices, the location indicators being depicted with differing visual characteristics depending the filtering of the metadata.

The program code is also executable to provide operations such as receiving a specified set of user parameters and applying the filtering of the metadata according to the specified set of user parameters to result in a targeted subset of the plurality of users, and depicting the location indicators for the targeted subset of the plurality of users with particular visual characteristics to visually distinguish the targeted subset of the plurality of users from others of the plurality of users.

Still further, the program code is executable for receiving a specified set of location parameters, identifying at least one location on the map image that satisfies the specified set of location parameters, and further filtering the metadata such that the targeted subset of the plurality of users includes only those that are located within a range of the at least one location on the map image.

The program code also supports the determination of strongly and weakly connected contacts. Here, the metadata may include information indicative of distinguishable levels of connection available for specification in the social networking information, wherein receiving the set of user parameters includes a specification of a given level of connection, such that the targeted subset of the plurality of users includes only those users satisfying the given level of connection. Alternatively, a weighted analysis of the parameters may be used to render a determination whether the other user/potential contact strongly or weakly matches the user request.

Alternative embodiments include a computer system having a processor and a memory that stores the program code that is executed by the processor to perform the described operations.

The application 500 is preferably provided as software, but may alternatively be provided as hardware, firmware, or any combination of software, hardware and/or firmware. A modular breakdown of the functionality of the application 500 comprises an input module 502, a social network metadata module 504, a location information module 506, a filtering module 508, a mapping module 510 and an invite module 512. Although one modular breakdown is illustrated, it should be understood that the described functionality may be performed by fewer, greater or differently named modules.

The input module 502 comprises a database that is used to convey options for gather parameters that can be specified by the user when seeking out friend contacts. Examples of the fields and corresponding values for these parameters are described above. The input module 502 is also configured to convey and receive location information and related commands in support of updating and determining the currently defined area against which gather parameters are to be applied. Still further, the input module 502 coordinates with the mapping module 510 in order to identify particular locations that may be input and specified by the user, such as particular establishments (clubs, restaurants, etc.) displayed on map images.

The social network metadata module 504 acquires and manages social networking metadata that is used to assess whether other users match the query parameters. The metadata may be separately maintained or may be acquired in response to a particular gather query. The metadata may be acquired via access to the social networking and other information available online and elsewhere.

The location information module 506 manages the location of the user device on which the application 500 is installed, and also works in conjunction with the mapping module 510 and user input to manage what constitutes the currently defined area when assessing gather queries.

The currently defined area may be the currently rendered map image for the user device on which the application 500 is installed, as dictated by the location determining technology of the device (GPS) and a default or specified range. Alternatively, the user may input a specified location (e.g., a location other than the current location of the device) and a specified range (e.g., 100 yards, 1 mile, 2 miles, 5 miles, etc.) in order to specify the currently defined area.

The location information module 506 also accesses the location information corresponding to other users. This allows the application 500 to apply the gather parameters against those other users within the currently defined area.

The filtering module 508 includes algorithms for applying the gather parameters to the social networking information in order to determine which other users match the gather parameters. As described previously, this may be a complete match of all specified parameters. Alternatively, it may be a determination of whether the other users strongly or weakly match the gather parameters. This may entail a weighted determination of matching based upon a ranking of the gather parameters input by the user.

The map module 510 supports determination of the currently defined area, as described above, and also renders the map images based upon the results of the filtering based upon the gather parameters. That is, the basic map for the currently defined area is illustrated, along with a graphical rendering of the other users that match the gather parameters, as well as any destination locations that are specified by the user (e.g., events, specific establishments, particular locations, etc.). The graphical rendering may include a distinguished rendering of matching user contacts against non-matching user contacts, such as “pink” versus “blue” dots for the respective contacts, as described.

Finally, the invite module 512 allows the user to invite the matching subset of other users to a meeting, event, etc., such as by an messaging facility available in the social network or otherwise.

Thus embodiments of the present invention produce and provide filtering of social networking information to provide customized mapping. Although the present invention has been described in considerable detail with reference to certain embodiments thereof, the invention may be variously embodied without departing from the spirit or scope of the invention. Therefore, the following claims should not be limited to the description of the embodiments contained herein in any way.

1. A method for displaying map images with depictions corresponding to user devices, the method comprising:
identifying a geographical area of interest;
accessing location information corresponding to a plurality of users as determined from the location of a plurality of user devices respectively associated with the plurality of users;
accessing social networking information comprising metadata respectively corresponding to individual ones of the plurality of users;
filtering the metadata to distinguish among subsets of the plurality of users;
displaying a map image corresponding to the geographical area of interest; and
depicting location indicators on the map image, the location indicators showing the locations of the plurality of user devices, the location indicators being depicted with differing visual characteristics depending the filtering of the metadata.

2. The method of claim 1, further comprising:
receiving a specified set of user parameters and applying the filtering of the metadata according to the specified set of user parameters to result in a targeted subset of the plurality of users; and
depicting the location indicators for the targeted subset of the plurality of users with particular visual characteristics to visually distinguish the targeted subset of the plurality of users from others of the plurality of users.

3. The method of claim 2, further comprising:
receiving a specified set of location parameters;
identifying at least one location on the map image that satisfies the specified set of location parameters; and
further filtering the metadata such that the targeted subset of the plurality of users includes only those that are located within a range of the at least one location on the map image.

4. The method of claim 2, wherein the metadata includes information indicative of distinguishable levels of connection available for specification in the social networking information, and wherein receiving the set of user parameters includes a specification of a given level of connection, such that the targeted subset of the plurality of users includes only those users satisfying the given level of connection.

5. The method of claim 2, wherein filtering the metadata to distinguish among subsets of the plurality of users includes determining a strength of connection between a requesting user and the plurality of users based upon the specified set of user parameters.

6. A computer program product for displaying map images with depictions corresponding to user devices, the computer program product comprising a computer readable medium having program code stored thereon, the program code being executable to perform operations comprising:
identifying a geographical area of interest;
accessing location information corresponding to a plurality of users as determined from the location of a plurality of user devices respectively associated with the plurality of users;
accessing social networking information comprising metadata respectively corresponding to individual ones of the plurality of users;
filtering the metadata to distinguish among subsets of the plurality of users;
displaying a map image corresponding to the geographical area of interest; and
depicting location indicators on the map image, the location indicators showing the locations of the plurality of user devices, the location indicators being depicted with differing visual characteristics depending the filtering of the metadata.

7. The computer program product of claim 6, wherein the operations further comprise:
receiving a specified set of user parameters and applying the filtering of the metadata according to the specified set of user parameters to result in a targeted subset of the plurality of users; and
depicting the location indicators for the targeted subset of the plurality of users with particular visual characteristics to visually distinguish the targeted subset of the plurality of users from others of the plurality of users.

8. The computer program product of claim 7, wherein the operations further comprise:
receiving a specified set of location parameters;
identifying at least one location on the map image that satisfies the specified set of location parameters; and
further filtering the metadata such that the targeted subset of the plurality of users includes only those that are located within a range of the at least one location on the map image.

9. The computer program product of claim 7, wherein the metadata includes information indicative of distinguishable levels of connection available for specification in the social networking information, and wherein receiving the set of user parameters includes a specification of a given level of connection, such that the targeted subset of the plurality of users includes only those users satisfying the given level of connection.

10. The computer program product of claim 7, wherein filtering the metadata to distinguish among subsets of the plurality of users includes determining a strength of connection between a requesting user and the plurality of users based upon the specified set of user parameters.

11. An apparatus for displaying map images with depictions corresponding to user devices, the apparatus comprising:
means for identifying a geographical area of interest;
means for accessing location information corresponding to a plurality of users as determined from the location of a plurality of user devices respectively associated with the plurality of users;
means for accessing social networking information comprising metadata respectively corresponding to individual ones of the plurality of users;
means for filtering the metadata to distinguish among subsets of the plurality of users;
means for displaying a map image corresponding to the geographical area of interest; and
means for depicting location indicators on the map image, the location indicators showing the locations of the plurality of user devices, the location indicators being depicted with differing visual characteristics depending the filtering of the metadata.

12. The apparatus of claim 11, further comprising:
means for receiving a specified set of user parameters and applying the filtering of the metadata according to the specified set of user parameters to result in a targeted subset of the plurality of users; and
means for depicting the location indicators for the targeted subset of the plurality of users with particular visual characteristics to visually distinguish the targeted subset of the plurality of users from others of the plurality of users.

13. The apparatus of claim 12, further comprising:
means for receiving a specified set of location parameters;
means for identifying at least one location on the map image that satisfies the specified set of location parameters; and
means for further filtering the metadata such that the targeted subset of the plurality of users includes only those that are located within a range of the at least one location on the map image.

14. The apparatus of claim 12, wherein the metadata includes information indicative of distinguishable levels of connection available for specification in the social networking information, and wherein receiving the set of user parameters includes a specification of a given level of connection, such that the targeted subset of the plurality of users includes only those users satisfying the given level of connection.

15. The apparatus of claim 12, wherein filtering the metadata to distinguish among subsets of the plurality of users includes determining a strength of connection between a requesting user and the plurality of users based upon the specified set of user parameters.
